(19) United States
(12) Patent Application Publication
(10) Pub. No.: US 2015/0252931 A1
(43) Pub. Date: Sep. 10, 2015

(54) QUICK CONNECT-DISCONNECT FLUID COUPLING

(71) Applicant: Keith Feldvoss SOLIMAR, Roberts, WI (US)

(72) Inventor: Keith Feldvoss SOLIMAR, Roberts, WI (US)

(21) Appl. No.: 14/197,011

(22) Filed: Mar. 4, 2014

(51) Int. Cl. F16L 37/18

(52) U.S. Cl. CPC F16L 37/18

(57) ABSTRACT

Embodiments relate to quick connect-disconnect couplings and related systems for facilitating fluid transfer. Quick connect-disconnect couplings as provided herein include two-bar linkage locking mechanisms having locking bars consisting of one linkage point. Systems as provided herein include quick connect-disconnect couplings and male adaptors.

### BACKGROUND

Many industries rely on the safe and efficient transfer of fluids and fluid materials between tanks, hoses, pipes, trucks, rail cars, conduits, and the like. In some cases, temporary fluid connections are necessary or preferred. One such common temporary fluid connection is a quick connect-disconnect fluid fitting, commonly known as a camlock fitting.

The conventional female camlock coupling typically includes a body defining an internal bore and a sealing surface, with two handles pivotally attached to the coupling body. The internal bore accepts a corresponding male adaptor having an arcuate peripheral groove and an engaging face. Actuating the coupling handles from an unlocked position to a locked position delivers the cam-shaped ends of the handles into the internal bore of the coupling. The peripheral arcuate groove of a male adaptor positioned within the coupling accepts the cam-shaped handle ends, and further actuation of the handles moves the adaptor engaging face to a position contiguous with the sealing surface to effect a fluid-tight seal. The handles lock into place against the peripheral arcuate groove of the male adaptor via friction, and are typically built of a softer metal such as brass.

### SUMMARY

In general, this disclosure describes techniques for quick connect-disconnect fluid couplings. Techniques further describe multi-bar linkage locking mechanisms. In particular, this disclosure describes techniques for fluid transfer. It should be noted that although the techniques of this disclosure are described with respect to examples for fluid transfer, the techniques described herein are generally applicable to other applications as will be readily apparent to those of skill in the art after review of this disclosure.

According to one example of this disclosure, a coupling comprises a body having a first end, a second end capable of receiving a free end of a male adaptor, an internal bore extending through the first end and the second end defining an internal surface, and a sealing surface; and at least one multi-bar linkage locking mechanism, each comprising a lever arm linkage member pivotally connected at a first pivot point to the body and pivotally attached at a second linkage point to a successive linkage member, and a locking bar linkage member, having a contacting end, and a linkage pivot point and pivotally attached to a preceding linkage member thereat; wherein actuating the lever arm linkage member from an unlocked position to a locked position extends the contacting bar into the internal bore of the body.

According to another example of the disclosure, a fluid material flow facilitation and control system comprises a male adaptor having a peripheral receiving groove, an engaging face, a mating end, and a second end; and a female coupling having: a body, an internal bore extending through the body and capable of receiving the male adaptor at a receiving end, a second end, a sealing surface, and at least one multi-bar linkage locking mechanism, each containing a lever arm linkage member pivotally connected at a first pivot point to the body and pivotally attached at a second linkage point to a successive linkage member, and a locking bar linkage member having a contacting end, and a linkage pivot point and pivotally attached to a preceding linkage member thereat; wherein actuating the at least one multi-bar linkage locking mechanism in a direction from an unlocked position to a locked position contiguously orients the male adaptor engaging face with the female coupling sealing surface thereby achieving a coupled system having a substantially leak-proof seal.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1A illustrates a combination front view and cross-sectional view of a prior art camlock fitting coupled to a male adaptor.

FIG. 1B illustrates a perspective view of a prior art male adaptor.

FIG. 2 illustrates a perspective view of a quick connect-disconnect coupling, according to one or more techniques of this disclosure.

FIG. 3A and FIG. 3B illustrate perspective views of multi-bar linkage locking mechanisms, according to one or more techniques of this disclosure.

FIG. 4A illustrates a cross-sectional view of a quick connect-disconnect coupling coupled with a male adaptor, according to one or more techniques of this disclosure.

FIG. 4B illustrates a cross sectional view of a multi-bar linkage locking mechanism in an over-the-center orientation, according to one or more techniques of this disclosure.

### DETAILED DESCRIPTION

The present invention relates to the well-known quick-connect-disconnect camlock couplings used across a myriad of industries for fluid material transfer between tanks, hoses, pipes, trucks, conduits, and the like. Embodiments herein provide a quick-connect-disconnect coupling for use in fluid material transfer. The embodiments described herein achieve increased coupling reliability, longevity, safety, and ease of use, while maintaining compatibility with industry-standard equipment. The embodiments described herein also provide for modularity and customizable aspects which obviate many problems inherent with the prior art and provide various further advantages as will be recognized by those of skill in the art after review of this disclosure.

As used herein, “a fluid” or “fluids” refers, air, gases, vapors, liquids, dispersions, emulsions, and fluidized solids or semi-solids.

Camlock couplings are popular for their simple construction and ease of use, but the basic friction-locking mechanism of camlock couplings creates significant reliability and failure issues. As the coupling handles are actuated, the cams move into the receiving groove of a male adaptor and typically substantially conform to at least a portion of the groove. This substantial conformation delivers generalized force vectors to the male adaptor ranging from radially inward to longitudinally upward towards the sealing face of the coupling. As a result, a significant portion of the actuating force applied to the handles works to create friction between the cams and the receiving groove of the male adaptor, rather than urging the male adaptor engaging face into the coupling diaphragm to create a seal.

Moreover, the force required to actuate the handles into the “locked” position is typically equal to or greater than the force required throughout the actuating path of the handles, making the handles in a locked position the functional equivalent of a boulder on a hill. The mechanism also does not provide the operator with an affirmative locking confirmation; rather, an operator will consider a locked position to be reached when the handle is position where little or no further actuating is possible. However, due to the design of the cams, and considering the significant wear which the cams and receiving grooves sustain over subsequent and repetitious use, the position of the handle does not necessary correlate to a reliably locked position.

Continued operation of a cam-lock coupling with a male adaptor built of a harder metal such as stainless steel will deform the cams and degrade the locking integrity of the coupling. Alternatively, repetitious operation of a cam-lock coupling with a male adaptor built of a softer material will deform the receiving groove of the adaptor and will similarly degrade the adaptor's ability to efficaciously seal with a corresponding coupling. When a coupling is used to transport thick fluids such as petroleum, slurries such as mixed cement, or fluidized powders such as starch or cement, the transported fluid can prevent ideal locking by caking the receiving groove and cams. Many typical operating environments, such as on tanker trucks or in series with pumps, can be highly vibrational or experience sporadic turbulence during operation that will cause the handles to rattle loose. High line pressures can also contribute to inadvertent opening of the coupling handles.

Where an electrolytic fluid is transferred through the coupling or present in the surrounding work environment, galvanic corrosion may occur between the cam and the adaptor receiving groove, between the handle-cam component and the coupling body, or between any contacting metal components having sufficient electropotential. Alloying or plating components can reduce electropotential difference to acceptable levels so as to avoid galvanic corrosion, yet such measures are often prohibitive due to the cost of materials or manufacture. Additionally, plating is effective only until constant friction between parts wears away the protective barrier.

Coupling failure ranging from leakage to complete detachment can be catastrophic, and result in lost product, damaged equipment, environmental contamination, and operator injury. As a result, many attempts to remedy the failure-prone nature of camlock couplings are present in the art; a few examples are to be found in Moore et al., U.S. Pat. No. 3,439,942 A; Vargo, U.S. Pat. No. 4,647,075; Barclay et al., U.S. Pat. No. 6,412,827 B1; Dixon, U.S. Pat. No. 8,172,271 B2; Parrish, U.S. Pat. No. 4,871,195; Lauffenburger et al., U.S. Pat. No. 3,976,313; Lauffenburger, U.S. Pat. No. 4,222,593; Goodall et al., U.S. Pat. No. 4,295,670; Burmeister, U.S. Pat. No. 7,354,077 B1; Mccarthy, U.S. Pat. No. 5,338,069; Dement, U.S. Pat. No. 8,286,829 B2; Lee et al., U.S. Pat. No. 5,911,445; Meyer, U.S. Pat. No. 6,053,540; Fahl, U.S. Pat. No. 6,015,168; Fahl et al., U.S. Pat. No. 5,791,694; Chen, U.S. Pat. No. 8,186,718 B2 and U.S. Pat. No. 6,120,065; Chang, U.S. Pat. No. 5,816,623 and U.S. Pat. No. 6,543,812 B1; Chen, U.S. Pat. No. 5,295,717 and U.S. Pat. No. 8,083,265 B1; Street, U.S. Pat. No. 5,988,693; Owens, U.S. Pat. No. 3,314,698 A; Collier, U.S. Pat. No. 6,447,016 B2; Kotake, U.S. Pat. No. 6,047,995; Chien, U.S. Pat. No. 6,224,113; and Goda, U.S. Pat. No. 6,089,619.

However, many of these solutions and others have not proven effective or efficient in practice as they introduce additional parts which negatively impact the coupling life-cycle by adding additional points of failure, increase production costs, require additional tools or loose parts which are easily lost, or require additional operational steps which operators may forego to save time or effort.

Embodiments described herein provide a female fluid coupling comprising at least one multi-bar linkage locking mechanism capable of locking in an over-the-center orientation. Such embodiments provide for more reliable locking, and reduced required actuating forces as compared to the prior art. The embodiments described herein further provide modularity and customizable aspects such that problems relating to materials of construction, such as material wear and galvanic corrosion, may be obviated. Additionally, the mutli-bar linkage locking mechanism and appurtenant components allow design flaws of the prior art to be addressed independently or in combination.

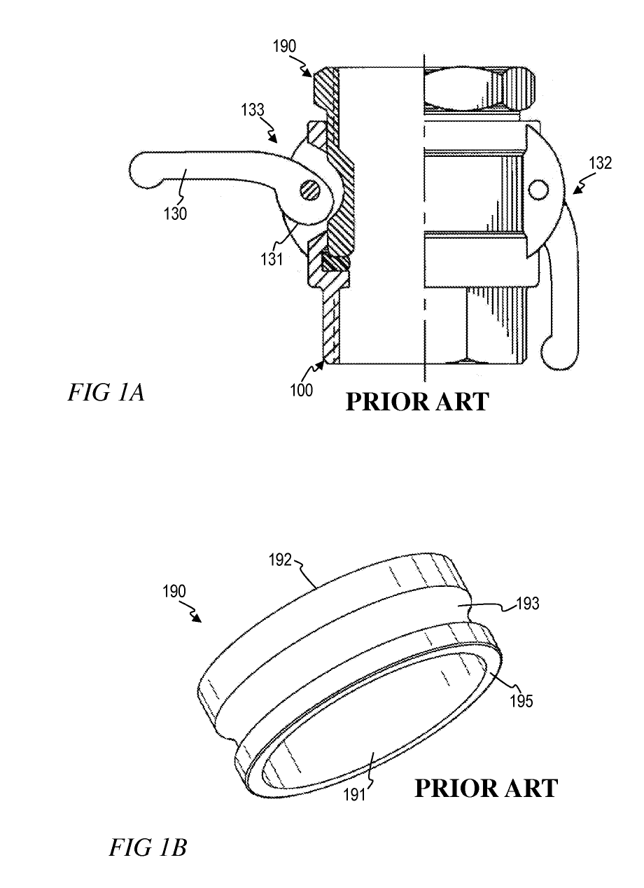

FIG. 1A shows a prior art camlock fitting 100 comprising locking arms 130 having cam-shaped ends 131 coupled to male adaptor 190. Locking arms 130 are shown in both unlocked position 131 and locked position 132. FIG. 1B a prior art male adaptor 190 comprising mating end 191, second end 192, peripheral arcuate groove 193 and engaging face 195.

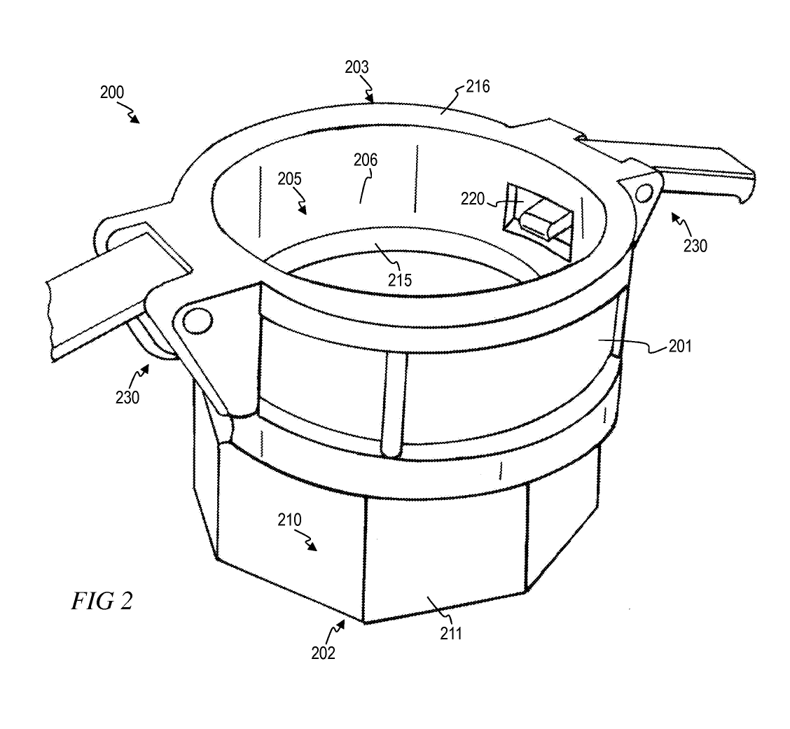

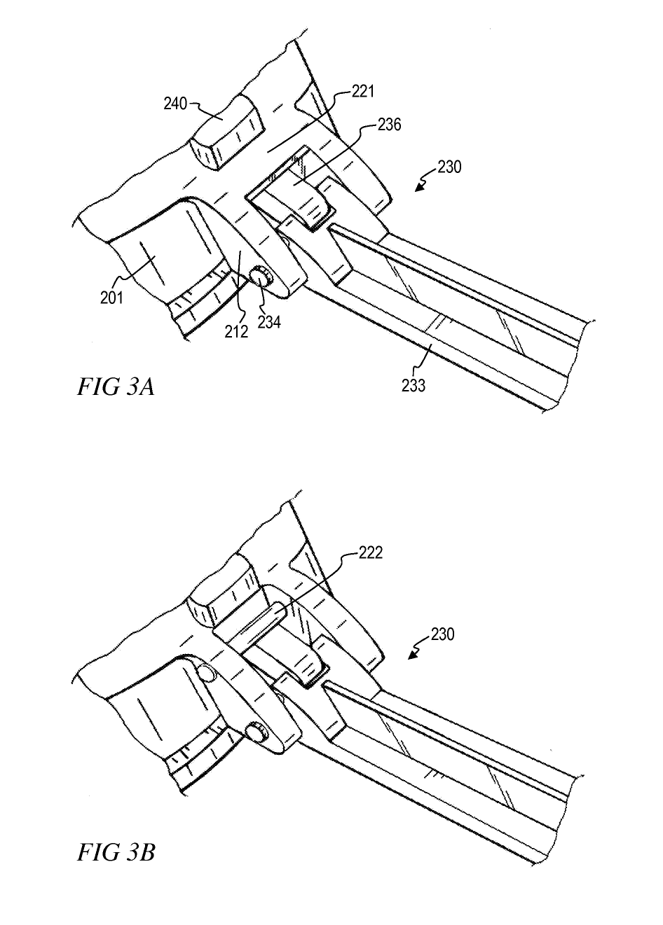

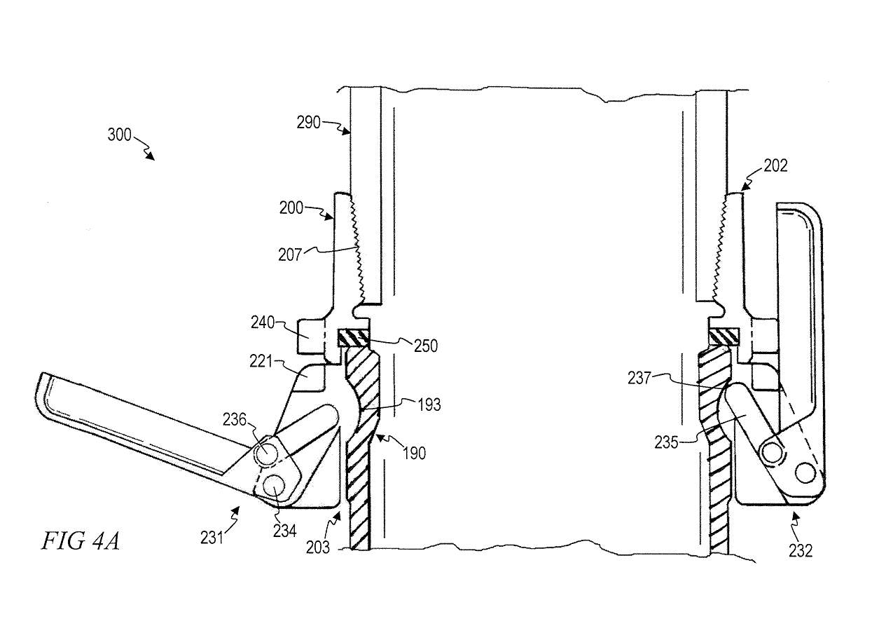

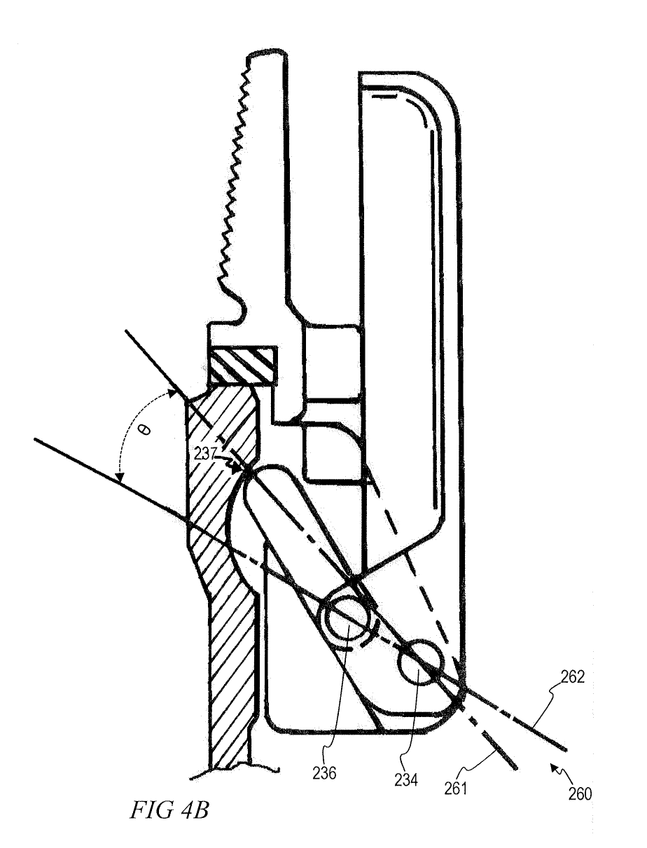

FIG. 2 shows an embodiment of a quick connect-disconnect coupling 200, comprising body 201, first end 202, second end 203, internal bore 205, internal surface 206, wrench-receiving contour 210, wrench receiving contour face 211, sealing surface 215, second end face 216, peripheral aperture 220, and locking mechanisms 230. Quick connect-disconnect coupling 200 comprises a body 201 having a first end 202, a second end 203, and an internal bore 205 extending through the first end 202 and the second end 203 thereby defining an internal surface 206. Second end 203, in some embodiments, is capable of accepting the mating end 191 of a male adaptor 190. In some embodiments, internal surface 206 can comprise threads 207 (shown in FIG. 4A). In some such embodiments, the threads are proximate the first end 202. Body 201 can be fashioned from metals, such as aluminum, iron, and the like, polymers and plastics, and other suitable materials as those of skill in the art would identify after review of this disclosure.

In some embodiments the body 201 and additionally or alternatively the internal bore 205 are substantially cylindrical. A stop extending radially inward from the internal surface 206 can form a sealing surface 215. A stop and a sealing surface can be sized based on the surface area and additionally or alternatively the radial distance as measured from the body internal surface necessary to effect a seal between a sealing surface and a male adaptor engaging face. In some embodiments, a stop and a sealing surface can be sized based on the shape and contour of a male adaptor. In some embodiments, a stop and a sealing surface can be sized based on the size, type, and material of a sealing member used therewith to effect a seal. In some embodiments, the sealing surface 215 is planar with a cross section of the internal bore 205. In some embodiments, second end 203 face 216 acts as a sealing surface. In other embodiments, sealing surface 215 and second end 203 face 216 both act as sealing surfaces.

In some embodiments, quick connect-disconnect coupling 200 comprises a wrench receiving contour 210 having a plurality of faces or facets 211 capable of engaging a wrench or other suitable tool. First end 202 in many embodiments is capable of connecting to one or more of a pipe, a hose, a vessel, or a material transport vehicle. In some embodiments, first end 202 comprises one or more of a female coupling, female threads, male threads, a male adaptor, a cylindrical pipe, a flange, a filter, a nozzle, a safety bump, a valve, a fluid diode, or a hose shank. First end 202 is capable of connecting to tanks, hoses, pipes, trucks, conduits. For example, first end 202 can connect to threaded element 290 (shown in FIG. 4A).

FIG. 3A shows a multi-bar linkage locking mechanism 230, lever arm 233, pivot point 234, locking bar linkage member 235, lever arm stop 240, body protrusions 212 and restraining means 221. Embodiments of quick connect-disconnect couplings 200 described herein can comprise one or a plurality of multi-bar linkage locking mechanisms 230. Locking mechanism 230, in many embodiments, is aligned with a radial aperture 220 (shown in FIG. 2). In some embodiments, the number of radial apertures 220 is equal to the number of locking mechanisms 230. In other embodiments, the number of radial apertures 220 differs from the number of locking mechanisms 230. For example, two or more locking mechanisms 230 may share a radial aperture. Locking mechanism 230 comprises a plurality of linkage members. A first linkage member is rotably attached to body 201. In some embodiments, the first linkage member is rotably attached to body protrusions 212. First linkage member can rotably attach to body 201 or body protrusion 212 with metal pins or the like. First linkage member can comprise a lever arm 233. Lever arm 233 can rotably attach to body 201 or body protrusion 212 at a pivot point 234. Lever arm 233 can rotably attach to a subsequent linkage member at pivot point 234 (shown in FIG. 4A). Lever arm 233 can further comprise pull rings, pull chains, or the like.

Locking mechanism 230 comprises a last linkage member, or locking bar linkage member 235. In some embodiments one or more linkage members are sequentially rotably attached between locking bar 235 and lever arm 233. In other embodiments, locking bar 235 is rotably attached to lever arm 233 at pivot point 236 (shown in FIG. 4A). Locking bar 235 may be fashioned from metal or plastic and polymer materials. Material of construction can be selected based on factors such as electrochemical potential between coupling 200 components, and male adaptor material.

Locking mechanism 230 can comprise a lever arm stop 240. In some embodiments stop 240 comprises a protrusion of body 201.

Locking mechanism 230 can comprise a restraining means 221. In some embodiments, restraining means 221 comprises the external contour of body 201. Restraining means 221 is suitably disposed such that locking bar 234 is maintained proximate radial aperture 220 radial aperture 220 (shown in FIG. 2). Restraining means 221 can ensure that locking bar 234 is directed towards and through radial aperture 220 upon actuating lever arm 231. FIG. 3A shows a multi-bar linkage locking mechanism 230 and an alternative restraining means 222. In some embodiments, restraining means 222 can comprise a pin. In some such embodiments, pin 222 is removable. Removable restraining means, such as 222, can facilitate component inspection, replacement, and repair, and can also increase ease of component assembly and/or disassembly. Removable restraining means 222 can be fashioned of materials such as metals, plastics and polymers, or other suitable materials as those of skill in the art would identify after review of this disclosure.

FIG. 4A shows quick connect-disconnect coupling 200, threads 207, restraining means 221, locking mechanism 230 in an unlocked position 231, locking mechanism 230 in a locked position 232, pivot point 234, pivot point 236, contact point 237, lever arm stop 240, sealing member 250, male adaptor 190, threaded element 290, and system 300.

Coupling 200 second end 203 is capable of accepting mating end 191 of male adaptor 190. Actuating lever arm 233 from an unlocked position 231 to a locked position 232 directs locking bar 235 through peripheral aperture 220 into internal bore 205. In some embodiments, locking bar 235 is directed initially substantially radially inward towards internal bore 205 and increasingly longitudinally upward towards the coupling 200 first end 202. When male adaptor 190 is disposed within coupling 200 internal bore 205, actuating lever arm 233 from an unlocked position 231 to a locked position 232 directs the locking bar 235 into the male adaptor 190 peripheral groove 193. Locking bar 235 contacts male adaptor 190 peripheral groove 193 at contact point 237, thereby coupling the coupling 200 and male adaptor 190. In locked position 232, male adaptor 190 engaging face 195 is contiguous with coupling 200 sealing surface 215, thereby forming a substantially leak-proof seal. In some embodiments, coupling 200 comprises a sealing member 250, such as an O-ring, or other compressible member capable of enhancing the sealing efficacy of the coupling 200 and male adaptor 190 system 300.

The direction of travel of locking bar 235 can reduce the required locking force as compared to a conventional camlock fitting because force generated by lever arm 233 is partially or substantially normal to the sealing surface 215.

A coupled system 300 can be achieved by orienting one or more locking mechanisms 230 in a locked position 232. System 300 facilitates fluid communication between coupling 200 first end 202 and male adaptor 190 second end 192 in either or both directions. System 300 can further comprise attached components at coupling 200 first end 202, such as element 290, and additionally or alternatively attached components at male adaptor 190 second end 192. Attached components can comprise tanks, hoses, pipes, trucks, conduits, and the like, or other suitable components as identified by those of skill in the art after review of this disclosure.

FIG. 4B shows a multi-bar linkage locking mechanism 230 in an over-the-center orientation 260. Throughout a locking motion, lever arm 233 is actuated from at or near an unlocked position 231 towards at a locked position 232. In some embodiments, lever arm 233 starts in the unlocked position 231 wherein the pivot point 234 is positioned above a line 261 formed by eventual contact point 237 between receiving groove 193 and locking bar 235, and pivot point 234. At a position between locked position 232 and unlocked position 231 the force required to actuate the lever arm 233 will reach a maximum. In some embodiments this maximum required actuating force can occur where the contact point 237, pivot point 234, and pivot point 236 are all aligned. If present in the embodiment, a sealing member 250 contiguous with coupling 200 sealing surface 215 and male adaptor 190 engaging face 195 can be most compressed. Further actuating lever arm 233 towards locked position 232 positions pivot point 236 below the line 261 formed by contact point 237 and pivot point 234 and into an over-the-center orientation 260.

In an over-the-center orientation 260, sealing member 250 can be compressed, but less compressed than at the maximum actuation force position. As a result, an “actuation force well” forms between the final locked position and the maximum actuation force position thereby maintaining the locking mechanism 230 in a locked position 232. Such an “actuation force well” can substantially increase the ability of a locking mechanism 230 to resist transition for a locked position 232 towards an unlocked position 231 due to factors including vibration, extraneous material such as dust or fluids present on peripheral groove 193, sealing member 250 shrinkage or wear, or other factors germane to coupling operating environments such as high fluid pressure. High locking reliability can be particularly essential from safety and environmental perspectives when working with high pressure, high pressure, or hazardous fluids. Further, the transition from the maximum actuation force position to the actuation force “well” will be noticeable to the operator and will provide assurance that the multi-bar linkage locking mechanism 230 has achieved a locked or substantially locked position.

In other embodiments, lever arm 233 starts in an unlocked position 231 wherein contact point 237, pivot point 234, and pivot point 236 are all aligned. In other embodiments, lever arm 233 stops in a locked position 232 wherein contact point 237, pivot point 234, and pivot point 236 are all aligned. In other embodiments, the maximum force required to actuate lever arm 233 occurs where the pivot point 236 is below line 261. In other embodiments, the maximum force required to actuate lever arm 233 occurs where pivot point 236 is positioned above line 261.

In some embodiments, the orientation of pivot point 234 and pivot point 236 on lever arm 233 can be modified to exaggerate the “over-the-center” orientation 260. For example, angle θ, as formed by line 261 and line 262, can be increased or decreased. Modifying θ can depend on sealing member 250 compressibility and/or thickness, locking bar 235 length, male adaptor 190 peripheral groove 193 depth, and other factors.

In some embodiments, lever arm 233 is designed such that a range of motion is restricted at or near the unlocked position 232. In some other embodiments, coupling 200 is alternatively or additionally designed such that a range of motion of lever arm 233 is restricted at or near the unlocked position 232. In other embodiments, not pictured, lever arm 233 and/or a coupling 200 body 201 can comprise adjustable and/or removable elements, which enable the range of motion of lever arm 233 at or near the unlocked position 232 to be modified. Such embodiments enhance the versatility of a coupling 200, for example by allowing locking bars 235 of different lengths and sizes to be used, or by accommodating varying orientations of pivot point 234 and pivot point 236. For example, where a multi-bar linkage locking mechanism 230 comprises a shorter locking bar 235, the range of motion of lever arm 233 thereof can be restricted such that locking bar 235 is maintained in position throughout the range of motion of lever arm 233 by the appurtenant radial aperture 220, restraining means 221, or combinations thereof. In other examples, where a multi-bar linkage locking mechanism 230 comprises a longer locking bar 235, the range of motion of lever arm 233 thereof can be extended such that locking bar 235 is maintained in position throughout the range of motion of lever arm 233 by the appurtenant radial aperture 220, restraining means 221, or combinations thereof, while still allowing lever arm 233 sufficient range of motion towards an unlocked position 231 in order to retract locking bar 235 from the internal bore 205 of coupling 200, thereby allowing a male adaptor 190 unimpeded entry thereinto. A longer locking bar 235 may be useful, for example, where a male adaptor 190 having a smaller than typical diameter is coupled with coupling 200, where male adaptor 190 peripheral groove 193 is deeper than a typical peripheral groove, or combinations thereof.

In other examples, as the distance between pivot point 134 and pivot point 236 increases, a greater range of motion of lever arm 233 towards the unlocked position 231 is required to retract locking bar 235 from coupling 200 internal bore 205. In some embodiments, the range of motion of lever arm 233 is adjusted to remove locking bar 235 from a restraining means 221 to allow for, for example, removal, maintenance, or inspection.

Some embodiments relate to a coupling with a capped or flanged second end. Such embodiments are useful for closing off hoses, receiving vessel ports, or discharging vessel ports, where said hoses, receiving vessel ports, or discharging vessel ports comprise a receiving groove. In other embodiments the hose, receiving vessel port, or discharging vessel port comprise a coupling, and can be closed using a component comprising a receiving groove on a first end and a cap or flange on a second end.

Some embodiments relate to a coupling 200 further comprising a valve located between first end 202 and second end 203. Such embodiments are useful for connecting to hoses, receiving vessels, or discharging vessels having a receiving groove end, to affect flow therethrough using the valve. The valve may be a reduced nipple valve, a ball valve, a check valve, a butterfly valve, a globe valve, a parallel gate valve, a wedge gate valve, a plug valve, a needle valve, a diaphragm valve, a pinch valve, a safety or relief valve, a piston valve, or other type of valve. In some embodiments coupling 200 second end 203 may be the same diameter as coupling 200 first end 202. In other embodiments coupling 200 second end 203 may have a reduced or expanded diameter, relative to the diameter of coupling 200 first end 202. Second end 203 may further comprise a coupling, male threads, female threads, a hose shank/barb, a receiving groove, a smooth pipe, a screen/filter, a safety bump, a fluid diode, or a nozzle.

1. A fluid quick connect-disconnect female coupling comprising:
a body including:
a first end,
a second end capable of receiving a free end of a male adaptor having an engaging face and a peripheral receiving groove,
an internal bore extending through the first end and the second end defining an internal surface, and
a plurality of peripheral apertures;
a stop extending radially inward from the internal surface forming a sealing surface; and
a plurality of multi-bar linkage locking mechanisms, each including:
a lever arm linkage member pivotally attached to the body at a first pivot point and actuatable to and between each of an unlocked position and a locked position,
a locking bar linkage member having a first end pivotally attached to the lever arm at a second pivot point, and a second free end including a contacting portion, and
a restraining means for maintaining the locking bar linkage member proximate one of the plurality of radial apertures of the body;
wherein actuating one or more of the lever arm linkage members from the unlocked position to the locked position extends the contacting portion of each corresponding locking bar through each corresponding peripheral aperture into the internal bore of the body in a direction substantially radially inward and increasingly longitudinally upward towards the body first end and into the peripheral receiving groove of the male adaptor, whereby the male adaptor engaging face is contiguously oriented with the coupling sealing surface thereby achieving a substantially leak-proof seal between the coupling and the male adaptor, and each of the plurality of multi-bar linkage locking mechanisms are capable of locking in an over-the-center orientation.

2. A fluid material flow facilitation and control system comprising:
a male adaptor having:
a peripheral receiving groove,
an engaging face,
a first mating end, and
a second male adaptor end; and
a female coupling having:
a body,
an internal bore extending through the body and capable of receiving the male adaptor first mating end at a first receiving end,
a second female coupling end,
a sealing surface, and
at least one two-bar linkage locking mechanism, consisting of:
a lever arm linkage member pivotally connected at a first pivot point to the body, and
a locking bar linkage member having a first end pivotally attached to the lever arm at a second pivot point, and a second free end including a contacting portion;
wherein actuating one of the at least one two-bar linkage locking mechanism in a direction from an unlocked position to a locked position contiguously orients the male adaptor engaging face with the female coupling sealing surface thereby achieving a coupled system having a substantially leak-proof seal.

3. (canceled)

4. The fluid material flow facilitation and control system of claim 2, wherein the second male adaptor end further comprises one or more of a female coupling, female threads, male threads, a male adaptor, a cylindrical pipe, a flange, a filter, a nozzle, a safety bump, a valve, a fluid diode, or a hose shank.

5. The fluid material flow facilitation and control system of claim 2, wherein the second female coupling end further comprises one or more of a female coupling, female threads, male threads, a male adaptor, a cylindrical pipe, a flange, a filter, a nozzle, a safety bump, a valve, a fluid diode, or a hose shank.

6. The fluid material flow facilitation and control system of claim 2, further comprising a sealing member contiguously oriented with at least one of the male adaptor engaging face and the female coupling sealing surface.

7. The fluid material flow facilitation and control system of claim 2, wherein the second male adaptor end and the second female coupling end of the coupled system are in fluid communication.

8. A coupling comprising:
a body having:
a first end,
a second end capable of receiving a free end of a male adaptor,
an internal bore extending through the first end and the second end defining an internal surface, and
a sealing surface; and
at least one two-bar linkage locking mechanism, containing:
a lever arm linkage member pivotally connected at a first pivot point to the body, and
locking bar linkage member having a first end pivotally attached to the lever arm at a second pivot point, and a second free end including a contacting portion;
wherein actuating the lever arm linkage member of one of the at least one multi-bar linkage locking mechanism from an unlocked position to a locked position extends the locking bar into the internal bore of the body.

9. (canceled)

10. The coupling of claim 8, wherein one of the at least one two-bar linkage locking mechanisms is capable of locking in an over-the-center orientation.

11. The coupling of claim 10, wherein locking the coupling in the over-the-center orientation creates an actuating force well.

12. The coupling of claim 8, wherein the sealing surface is defined by a stop extending radially inward from the internal surface.

13. The coupling of claim 8, wherein the sealing surface is planar with a cross section of the internal bore.

14. The coupling of claim 8, wherein the sealing surface is defined by the body second end.

15. The coupling of claim 8, wherein one or more of the at least one two-bar linkage locking mechanisms further comprises a locking bar linkage member restraining means.

16. The coupling of claim 15, wherein the restraining means is removable.

17. The coupling of claim 8, wherein the body further comprises a wrench-receiving contour.

18. The coupling of claim 8, further comprising a sealing member contiguously oriented with the sealing surface.

19.-20. (canceled)

21. The fluid quick connect-disconnect female coupling of claim 2, further comprising a sealing member contiguously oriented with at least one of the male adaptor engaging face and the female coupling sealing surface.

22. The fluid quick connect-disconnect female coupling of claim 1, wherein each locking bar linkage member of the plurality of multi-bar linkage locking mechanisms includes at most one linkage pivot point.

23. The coupling of claim 2, wherein each of the at least one two-bar linkage locking mechanisms consist of at most two linkage bars.

24. The fluid material flow facilitation and control system of claim 8, wherein the locking bar linkage member of the at least one two-bar linkage locking mechanism includes at most one linkage pivot point.
